(19) United States
(12) Patent Application Publication
(10) Pub. No.: US 2025/0174249 A1
(43) Pub. Date: May 29, 2025

(54) WRONG PHRASE REPLACEMENT

(71) Applicant: International Business Machines Corporation, Armonk, NY (US)

(72) Inventors: Jun Su, Beijing (CN); YANG LIANG, Beijing (CN); Su Liu, Austin, TX (US); Fan Yang, Beijing (CN)

(21) Appl. No.: 18/520,611

(22) Filed: Nov. 28, 2023

(51) Int. Cl. G11B 27/031; G10L 15/02; G10L 21/10

(52) U.S. Cl. CPC G11B 27/031; G10L 15/02; G10L 21/10; G10L 2015/025; G10L 2021/105

(57) ABSTRACT

According to one embodiment, a method, computer system, and computer program product for wrong phrase replacement is provided. The embodiment may include, in response to identifying an error spoken by a presenter in a multimedia file, generating a plan to correct the error. The embodiment may also include generating a corrected audio segment based on the plan. The embodiment may further include replacing an original audio segment in the multimedia file containing the error with the corrected audio segment. The embodiment may also include modifying a lip movement in a video segment of the multimedia file so lip movements of the presenter correspond to respective phonetics in the corrected audio segment. The embodiment may further include replacing an original lip movement with the modified lip movement so that the modified lip movement corresponds with the corrected audio segment.

### BACKGROUND

The present invention relates generally to the field of computing, and more particularly to video editing.

Video editing is the post-production process of modifying images and audio segments to create a new product. Video editing includes trimming, resequencing, and adding segments of audio and video and other effects. With the advancement of computing technology, video editing has become more accessible to both professionals and non-professionals. Modern video editing techniques include, but are not limited to, color correction, titling, sound mixing, and visual effects composting.

Similar to video editing, audio editing relates to the post-production process of an audio segment but eliminates image-related aspects. In essence, audio editing relates to any process that alters the waveform of an original audio segment. Audio editing allows for the manipulation of sound waves in an audio clip to identify or correct errors and/or enhance quality. Typical audio editing techniques include, but are not limited to, cutting, copying, pasting, and applying filters.

### SUMMARY

According to one embodiment, a method, computer system, and computer program product for wrong phrase replacement is provided. The embodiment may include, in response to identifying an error spoken by a presenter in a multimedia file, generating a plan to correct the error. The embodiment may also include generating a corrected audio segment based on the plan. The embodiment may further include replacing an original audio segment in the multimedia file containing the error with the corrected audio segment. The embodiment may also include modifying a lip movement in a video segment of the multimedia file so lip movements of the presenter correspond to respective phonetics in the corrected audio segment. The embodiment may further include replacing an original lip movement with the modified lip movement so that the modified lip movement corresponds with the corrected audio segment.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for a wrong phrase replacement process according to at least one embodiment.

FIG. 3 illustrates a functional block diagram of software components used in a wrong phrase replacement process according to at least one embodiment.

FIG. 4 illustrates an exemplary flowchart for synthesizing a speaker's audio and synchronizing lip animations according to at least one embodiment.

### DETAILED DESCRIPTION

According to an aspect of the invention, there is provided a processor-implemented method that includes, in response to identifying an error spoken by a presenter in a multimedia file, generating a plan to correct the error; generating a corrected audio segment based on the plan; replacing an original audio segment in the multimedia file containing the error with the corrected audio segment; modifying a lip movement in a video segment of the multimedia file so lip movements of the presenter correspond to respective phonetics in the corrected audio segment; and replacing an original lip movement with the modified lip movement so that the modified lip movement corresponds with the corrected audio segment. This aspect of the invention may allow for a video correction strategy that uses leveraged, advanced technologies in phoneme synthesis, voice synthesis, lip synchronization, and audio processing.

In embodiments, generating the corrected audio segment in the method further includes extracting the original audio segment from the multimedia file; translating the original audio segment to phonetic elements; identifying one or more phonetic elements of the original audio segment associated with the error; identifying one or more phonetic elements, in the original audio segment or in a historical correction log, that correspond to a corrected word or phrase in the corrected audio segment; and generating the corrected audio segment from the one or more phonetic elements that correspond to the corrected word or phrase, where these claim elements are separable or optional. This aspect of the invention may allow for the seamless generation of the corrected audio segment using phonetic elements in the original audio segment or in a historical correction log.

In embodiments, identifying an error in the method further includes separating the original audio segment based on a speaker or by sentence, parsing the separated original audio segments into phonetic elements, and identifying an error within the phonetic elements based on a machine learning model or a historical correction log, where these claim elements are separable or optional. This aspect of the invention may allow for accurate identification of errors in a multimedia file based on analyzing phonetic elements in an audio segment using a machine learning model and comparison against a historical correction log.

In embodiments, generating the plan in the method further includes utilizing a machine learning model or a historical correction log to determine a best fit word or phrase to place the error in the multimedia file. This aspect of the invention may allow for accurate identification of errors present in a multimedia file by using a machine learning model or a historical correction log.

In embodiments, the method may further include prompting a user to confirm updates prior to saving or uploading the multimedia file with corrected audio segment and replaced lip movement, where confirming includes the user being verified as the presenter in the multimedia file using biometric data. This aspect of the invention may verify that the presenter depicted in the multimedia file is the user making the changes made to the multimedia file.

In embodiments, replacing the original audio segment in the method further includes modifying a speech characteristic of audio data juxtaposed to the corrected audio segment in the multimedia file, where the speech characteristic is selected from a group consisting of tone, inflection, and volume. This aspect of the invention may detail that audio surrounding the corrected audio segment being added to the multimedia file to correct an error may have characteristics, such as tone, inflection, and volume, in order to match the characteristics of the corrected audio segment and ensure a smooth, seamless multimedia file.

In embodiments, the error in the method is selected from a group consisting of a language error, a grammatical mistake, and inappropriate content. This aspect of the invention further details that the error may be a language error, a grammatical mistake, and inappropriate content, which specifies that modification of the multimedia file may be limited to these areas.

According to an aspect of the invention, there is provided a computer system that includes one or more processors, one or more computer-readable memories, one or more computer-readable tangible storage media, and program instructions stored on at least one of the one or more tangible storage media for execution by at least one of the one or more processors via at least one of the one or more memories, where the computer system is capable of performing a method that includes, in response to identifying an error spoken by a presenter in a multimedia file, generating a plan to correct the error; generating a corrected audio segment based on the plan; replacing an original audio segment in the multimedia file containing the error with the corrected audio segment; modifying a lip movement in a video segment of the multimedia file so lip movements of the presenter correspond to respective phonetics in the corrected audio segment; and replacing an original lip movement with the modified lip movement so that the modified lip movement corresponds with the corrected audio segment. This aspect of the invention may allow for a video correction strategy that uses leveraged, advanced technologies in phoneme synthesis, voice synthesis, lip synchronization, and audio processing.

In embodiments, generating the corrected audio segment in the computer system further includes extracting the original audio segment from the multimedia file; translating the original audio segment to phonetic elements; identifying one or more phonetic elements of the original audio segment associated with the error; identifying one or more phonetic elements, in the original audio segment or in a historical correction log, that correspond to a corrected word or phrase in the corrected audio segment; and generating the corrected audio segment from the one or more phonetic elements that correspond to the corrected word or phrase, where these claim elements are separable or optional. This aspect of the invention may allow for the seamless generation of the corrected audio segment using phonetic elements in the original audio segment or in a historical correction log.

In embodiments, identifying an error in the computer system further includes separating the original audio segment based on a speaker or by sentence, parsing the separated original audio segments into phonetic elements, and identifying an error within the phonetic elements based on a machine learning model or a historical correction log, where these claim elements are separable or optional. This aspect of the invention may allow for accurate identification of errors in a multimedia file based on analyzing phonetic elements in an audio segment using a machine learning model and comparison against a historical correction log.

In embodiments, generating the plan in the computer system further includes utilizing a machine learning model or a historical correction log to determine a best fit word or phrase to place the error in the multimedia file. This aspect of the invention may allow for accurate identification of errors present in a multimedia file by using a machine learning model or a historical correction log.

In embodiments, the method performed by the computer system may further include prompting a user to confirm updates prior to saving or uploading the multimedia file with corrected audio segment and replaced lip movement, where confirming includes the user being verified as the presenter in the multimedia file using biometric data. This aspect of the invention may verify that the presenter depicted in the multimedia file is the user making the changes made to the multimedia file.

In embodiments, replacing the original audio segment in the computer system further includes modifying a speech characteristic of audio data juxtaposed to the corrected audio segment in the multimedia file, where the speech characteristic is selected from a group consisting of tone, inflection, and volume. This aspect of the invention may detail that audio surrounding the corrected audio segment being added to the multimedia file to correct an error may have characteristics, such as tone, inflection, and volume, in order to match the characteristics of the corrected audio segment and ensure a smooth, seamless multimedia file.

In embodiments, the error in the computer system is selected from a group consisting of a language error, a grammatical mistake, and inappropriate content. This aspect of the invention further details that the error may be a language error, a grammatical mistake, and inappropriate content, which specifies that modification of the multimedia file may be limited to these areas.

According to an aspect of the invention, there is provided a computer program product that includes one or more computer-readable tangible storage media and program instructions stored on at least one of the one or more tangible storage media, the program instructions executable by a processor capable of performing a method, where the method includes, in response to identifying an error spoken by a presenter in a multimedia file, generating a plan to correct the error; generating a corrected audio segment based on the plan; replacing an original audio segment in the multimedia file containing the error with the corrected audio segment; modifying a lip movement in a video segment of the multimedia file so lip movements of the presenter correspond to respective phonetics in the corrected audio segment; and replacing an original lip movement with the modified lip movement so that the modified lip movement corresponds with the corrected audio segment. This aspect of the invention may allow for a video correction strategy that uses leveraged, advanced technologies in phoneme synthesis, voice synthesis, lip synchronization, and audio processing.

In embodiments, generating the corrected audio segment in the computer program product further includes extracting the original audio segment from the multimedia file; translating the original audio segment to phonetic elements; identifying one or more phonetic elements of the original audio segment associated with the error; identifying one or more phonetic elements, in the original audio segment or in a historical correction log, that correspond to a corrected word or phrase in the corrected audio segment; and generating the corrected audio segment from the one or more phonetic elements that correspond to the corrected word or phrase, where these claim elements are separable or optional. This aspect of the invention may allow for the seamless generation of the corrected audio segment using phonetic elements in the original audio segment or in a historical correction log.

In embodiments, identifying an error in the computer program product further includes separating the original audio segment based on a speaker or by sentence, parsing the separated original audio segments into phonetic elements, and identifying an error within the phonetic elements based on a machine learning model or a historical correction log, where these claim elements are separable or optional. This aspect of the invention may allow for accurate identification of errors in a multimedia file based on analyzing phonetic elements in an audio segment using a machine learning model and comparison against a historical correction log.

In embodiments, generating the plan in the computer program product further includes utilizing a machine learning model or a historical correction log to determine a best fit word or phrase to place the error in the multimedia file. This aspect of the invention may allow for accurate identification of errors present in a multimedia file by using a machine learning model or a historical correction log.

In embodiments, the method performed by the computer program product may further include prompting a user to confirm updates prior to saving or uploading the multimedia file with corrected audio segment and replaced lip movement, where confirming includes the user being verified as the presenter in the multimedia file using biometric data. This aspect of the invention may verify that the presenter depicted in the multimedia file is the user making the changes made to the multimedia file.

In embodiments, replacing the original audio segment in the computer program product further includes modifying a speech characteristic of audio data juxtaposed to the corrected audio segment in the multimedia file, where the speech characteristic is selected from a group consisting of tone, inflection, and volume. This aspect of the invention may detail that audio surrounding the corrected audio segment being added to the multimedia file to correct an error may have characteristics, such as tone, inflection, and volume, in order to match the characteristics of the corrected audio segment and ensure a smooth, seamless multimedia file.

In embodiments, the error in the computer program product is selected from a group consisting of a language error, a grammatical mistake, and inappropriate content. This aspect of the invention further details that the error may be a language error, a grammatical mistake, and inappropriate content, which specifies that modification of the multimedia file may be limited to these areas.

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to video editing. The following described exemplary embodiments provide a system, method, and program product to, among other things, provide a video correction strategy that uses leveraged, advanced technologies in phoneme synthesis, voice synthesis, lip synchronization, and audio processing. Therefore, the present embodiment has the capacity to improve the technical field of video editing by enabling the seamless correction of recording errors or mistakes without requiring a recapture of the recording using user-recorded phonetic elements, audio synthesis, and lip synchronization.

As previously described, video editing is the post-production process of modifying images and audio segments to create a new product. Video editing includes trimming, resequencing, and adding segments of audio and video and other effects. With the advancement of computing technology, video editing has become more accessible to both professionals and non-professionals. Modern video editing techniques include, but are not limited to, color correction, titling, sound mixing, and visual effects composting.

Similar to video editing, audio editing relates to the post-production process of an audio segment but eliminates image-related aspects. In essence, audio editing relates to any process that alters the waveform of an original audio segment. Audio editing allows for the manipulation of sound waves in an audio clip to identify or correct errors and/or enhance quality. Typical audio editing techniques include, but are not limited to, cutting, copying, pasting, and applying filters.

Common techniques and terms in the editing technologies include phoneme synthesis, voice synthesis, audio processing, and real-time processing. Phoneme synthesis relates to the utilization of natural language processing and phoneme synthesis models to generate phonetic representations of corrected words. Voice synthesis relates to the application of voice creation techniques (e.g., text-to-speech) to recreate the speaker's voice for specific content. Audio processing relates to the seamless integration of synthesized segments within an original audio clip while maintaining timing and context of the presented audio. Real-time processing relate to providing editing or processing capabilities in a real-time, or near real-time, manner for efficient correction during content creation and editing.

In the ever-evolving landscape of user-generated content, the emergence of short form videos has redefined how individuals and businesses communicate, entertain and engage with audiences. Short form videos relate to video recordings that span a length of 30 to 180 seconds and, currently, are expanding in popularity on communication platforms. Short form video platforms have gained tremendous popularity and have become a significant trend in the world of communication and digital entertainment. These platforms offer a unique and engaging experience for users to create, share, and discover short videos with a wide range of content, from dance challenges and comedic sketches to educational tutorials and product showcases. The “bite-sized” nature of these videos makes them highly shareable and consumable by users and caters to the fast-paced and visually oriented preferences of modern audiences.

Short form video publishing is characterized by its speed, dynamic engagement, and adaptability to trends, while long form video creation offers a more comprehensive and deliberate approach to content production. Various differences in the two forms existing including, but not limited to, pace of publishing, audience engagement and interaction, content styles and focus, and platform dynamics.

With respect to pace of publishing, short form videos are typically shorter in duration (e.g., under 60 seconds) and require less time to create and edit. Also, creators of short form videos often produce and publish short videos rapidly, allowing for timely responses to trends, challenges, and current events. Creators of short form videos may also post multiple videos in a single day, which maintains a consistent flow of content to engage audiences.

For audience engagement and interaction, short form videos allow for rapid user engagement generation, which often results in quick likes, comments, and shares. Creators of the short form videos can also interact with their audience in real time, responding to comments and engaging in conversations. Due to the quick and shareable nature of short form videos, content can quickly go viral and garner widespread attention.

Short videos are also designed for quick consumption and attention-grabbing content that captures the view's interest in seconds. Creators of short form videos often participate in viral challenges and trends, adapting their content to match current popular themes. Furthermore, many short form platforms use algorithms to surface content to users, often prioritizing recent and engaging videos.

However, due to the nature of short form videos (e.g., high volume, fast pace, content-driven, immediate feedback, dynamic interaction, vital potential, etc.), many mistakes may be introduced, such as, but not limited to, slips of the tongue, language errors, grammatical mistakes, and inappropriate content that can hinder the overall quality and impact of the content. As such, it may be advantageous to, among other things, develop a program capable of regulating and moderating short video through a user-friendly interface and platform that empowers administrators, creators, and audiences to intelligently, dynamically, periodically, and automatically correct, review, adjust, and approve post video content corrections.

According to at least one embodiment, a wrong phrase replacement program may leverage advanced technologies in phoneme synthesis, voice synthesis, lip synchronization, and audio processing to identify language errors, mispronunciations, and restricted words withing an original, user-created video, correct the identified errors with artificial intelligence (AI)-synthesized audio and associated synchronized speaker lip animations, and update the original video with the corrected video accordingly. More specifically, the wrong phrase replacement program may scan and identify language errors, mispronunciations, and restricted words within each original video uploaded by a user, recommend a plan for correcting the identified issues, generate accurate phonetic elements (phonemes) of the corrections required according to the recommended correction phrases, synthesize the corrected audio segments based on the generated accurate phonetic elements, integrate the synthesized corrected audio segments into the original audio content while preserving the natural flow and tone of the creator's speech, synchronize the corrected lip animation of speakers in the video according to the synthesized corrected audio segments and speaker's lip animation patterns, and update the original video with the corrected video.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

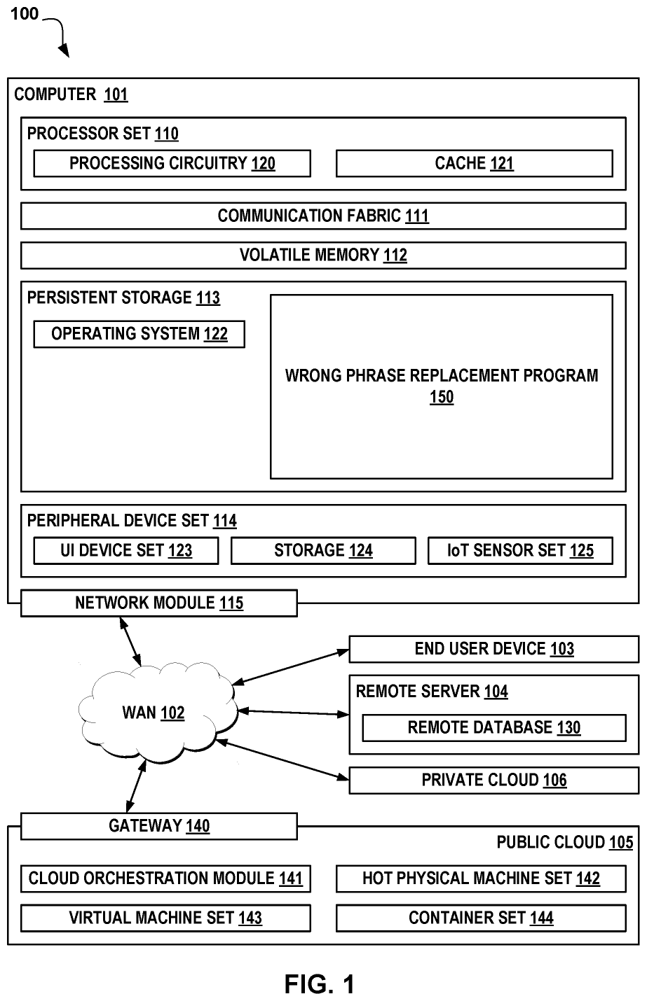

Referring now to FIG. 1, computing environment 100 contains an example of an environment for the execution of at least some of the computer code involved in performing the inventive methods, such as wrong phrase replacement program 150. In addition to wrong phrase replacement program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and wrong phrase replacement program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer, or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in video wrong phrase replacement program 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in video wrong phrase replacement program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to at least one embodiment, the video wrong phrase replacement program 150 may analyze a video uploaded by a user for various errors, such as grammar, inappropriate content, and linguistic errors. Upon determining such errors exist, the video wrong phrase replacement program 150 may generate a plan to correct the identified errors and then implement the generated plan. The video wrong phrase replacement program 150 may comprise a framework for empowering administrators, creators, and/or audiences to correct, review, adjust and approve video content corrections. The video wrong phrase replacement program 150 may allow for defining a data structure with related algorithms for saving, tracking, and updating data, such as, but not limited to, a video ID, an audio segment ID, an audio speaker ID, an audio time length, an audio text segment ID, an audio text speaker IDS, an audio text time length, a video segment ID, a video speaker ID, a video time length, wrong phrase text, wrong phrase audio, wrong phrase lip animation, correct phrase text, correct phrase audio, correct phrase lip animation, and updated correct caption and audio. Furthermore, the video wrong phrase replacement program 150 may allow users (e.g., administrators, creators, and/or audiences) to configure and customize settings, attributes and/or criteria, restricted words/phrases with suggested replacement candidates, etc. In one or more embodiments, the video wrong phrase replacement program 150 may also learn wrong-correct phrases from a defined wrong-correct mapping logics and correction log, receive regulating and moderating requests from users, scan each original media (e.g., audio and/or video) in a user selected set of media files in a short-form video server (e.g., computer 101, remote server 104, and/or private cloud 106), segment media content according to speaker/role or by sentence, parse a segment into basic elements (e.g., word phrase and associated phonemes), identify wrong phrases spoken in audio in the segment, recommend a correct phrase with which to replace the wrong phrases, generate accurate phonetic elements (phonemes) of the corrections required according to the recommended correction phrases and speakers' voice profiles, synthesize the corrected audio segments based on the generated accurate phonetic elements, integrate the synthesized corrected audio segments into the original audio content while preserving the natural flow and tone of the speaker's speech, synchronize the correlated lip animation of speakers in the associated video according to the integrated corrected audio, replace the wrong phrase lip animation with the synchronized lip animation, and update the original video segment with the moderated segment and save the moderation records within the correction log.

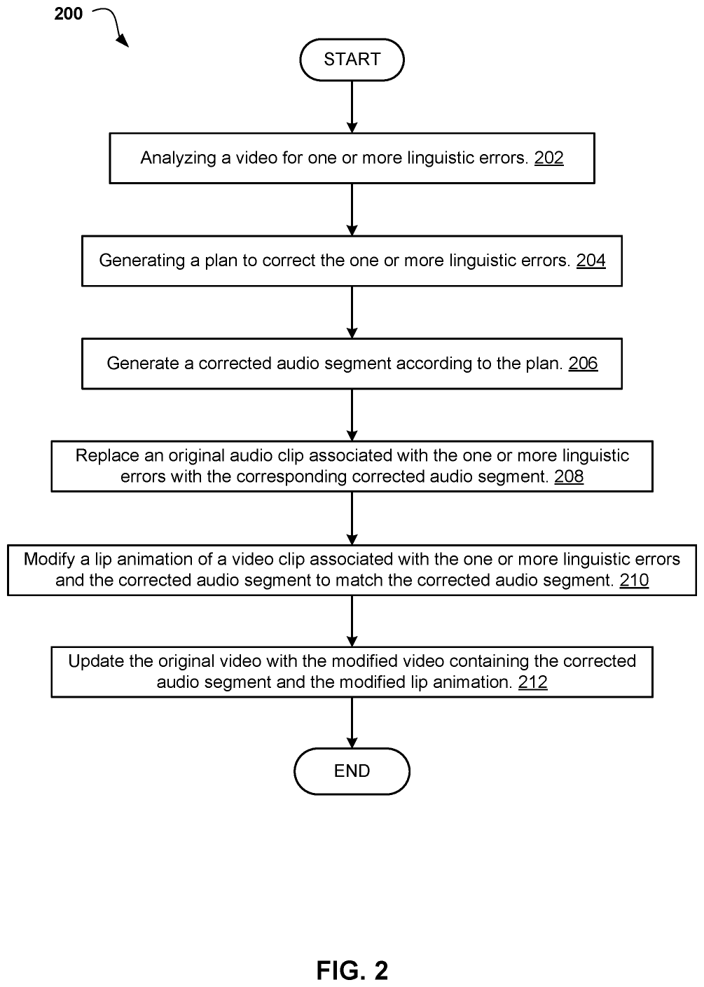

Additionally, prior to initially performing any actions, the video wrong phrase replacement program 150 may perform an opt-in procedure. The opt-in procedure may include a notification of the data the video wrong phrase replacement program 150 may capture and the purpose for which that data may be utilized by the video wrong phrase replacement program 150 during data gathering and operation. Furthermore, notwithstanding depiction in computer 101, the video wrong phrase replacement program 150 may be stored in and/or executed by, individually or in any combination, end user device 103, remote server 104, public cloud 105, and private cloud 106. The context-aware voice self-authorization method is explained in more detail below with respect to FIGS. 2-4.

Referring now to FIG. 2, an operational flowchart for a video wrong phrase replacement process 200 according to at least one embodiment. At 202, the video wrong phrase replacement program 150 analyzes a video for one or more linguistic errors. As previously described, the creation of short form videos is often a quick process. As such, many errors may be experienced during the recording process. As a first step, the video wrong phrase replacement program 150 may identify various errors within recorded short form videos, such as, but not limited to, language errors (e.g., incorrect verb tense), grammatical mistakes (e.g., improper singularization or pluralization), and inappropriate content (e.g., untoward words of phrases). For example, the video wrong phrase replacement program 150 may analyze a short form video where a presenter states “When we invest in clean energy and electric vehicles and reduce population, more of our children can breathe clean air and drink clean water”. The video wrong phrase replacement program 150, utilizing a module for learning wrong-correct phrases from mapped logics and a historical correction log, may determine the word “population” is incorrectly used in the sentence. Although a word of phrase may not be linguistically incorrect in a particular sentence, the video wrong phrase replacement program 150 may understand that the use of certain words or phrases may alter the intended meaning of a phrase or sentence to have unintended meanings that require correction.

In order to identify the specific errors within a video, the video wrong phrase replacement program 150 may utilize a segmentor module that separates the media content within the short form video into segments according to speaker/role or sentence separators. Then, the video wrong phrase replacement program 150 may utilize a segment parser to separate a segment into basic elements, such as words, phrases, or associated phonemes (e.g., phonetic elements). An error identifier may then be utilized to identify the specific errors within the segmented basic elements. For example, the video wrong phrase replacement program 150 may utilize the segmentor module, segment parser, and error identifier on the spoken sentence “When we invest in clean energy and electric vehicles and reduce population, more of our children can breathe clean air and drink clean water” to determine that the word “population” is an error within the video since its use either violates linguistic rules or appropriateness standards which may be stored in the correction log of historical corrections, the wrong-correct mapped logics, another repository of typical errors, or a machine learning model capable of identifying errors within human speech.

Although the video wrong phrase replacement program 150 may be described with respect to short form videos in one or more examples below, the video wrong phrase replacement program 150 may be utilized with any multimedia file, form, or format. Furthermore, the video wrong phrase replacement program 150 may be utilized, in whole or in part, with wrong phrase replacement in audio formats by omitting any video-related correction processes.

Then, at 204, the video wrong phrase replacement program 150 generates a plan to correct the one or more linguistic errors. Once the video wrong phrase replacement program 150 has analyzed the recorded short form video and identified specific errors within the video, the video wrong phrase replacement program 150 may generate a plan aimed to correct the identified errors. The video wrong phrase replacement program 150 may utilize a correction recommender to determine which word or phrase that is a best fit to replace the error. The video wrong phrase replacement program 150, through the correction recommender, may analyze either the entire spoken sentence, in order to determine the context in which the error was spoken, or identify a historical correction for the error from the historical correction log to identify the word or phrase that was intended for use by the speaker in the short form video. For example, the video wrong phrase replacement program 150 may determine that the word “population” in the spoken sentence “When we invest in clean energy and electric vehicles and reduce population, more of our children can breathe clean air and drink clean water” is most likely meant to be “pollution” based on the context of the sentence and historical errors within the correction log or a machine learning model.

Next, at 206, the video wrong phrase replacement program 150 generates a corrected audio segment according to the plan. In order to generate a corrected audio segment, the video wrong phrase replacement program 150 may utilize a phoneme generator on the short form video, or a portion of the short form video, in order to extract audio bits spoken by the presenter and create the intended word from the extracted audio bits. The phoneme generator may translate or generate accurate phonetic elements (phonemes) of the corrections required according to the recommended correction phrases and speaker's voice profile. For example, if the video wrong phrase replacement program 150 determines the intended word from the above example is “pollution”, the video wrong phrase replacement program 150, using the phoneme generator may determine the phonetic elements of the word “pollution” to be “ [symbol] ”.

In at least one embodiment, the video wrong phrase replacement program 150, using the phoneme generator, may generate the phonetic elements for the short form video. For example, the video wrong phrase replacement program 150 may generate the phonetic elements of the sentence “When we invest in clean energy and electric vehicles and reduce population, more of our children can breathe clean air and drink clean water” as “w [symbol] n wi vest in ”. klin [symbol] [symbol] [symbol] m [symbol] r av a [symbol] r [symbol] [symbol] klin er and dri [symbol] klin

[symbol]

Once the phonetic elements of the correct word are determined, the video wrong phrase replacement program 150 may generate the correct word from various phonetic elements in the recorded short form video. The video wrong phrase replacement program 150 may parse through the phonetic elements of the short form video to identify specific phonetic elements that can be combined through audio synthesis to create the correct word or phrase according to the generated plan. Additionally, the video wrong phrase replacement program 150 may utilize phonetic elements in the correction log of historical corrections for specific phonetic elements needed to generate the correct word or phrase. For example, the video wrong phrase replacement program 150 may identify various elements in the phonetic translation of the short form video (i.e., “/wen wi in vest in klin [symbol] and [symbol] mer av [symbol] [symbol] klin er and drink klin [symbol] ”) to identify various phonetic elements that can be combined to create correct word “pollution”. If the video wrong phrase replacement program 150 is unable to identify all phonetic elements to create the correct word through the phonetic elements of the short form video as translated by the phoneme generator or if it more efficient to utilize phonetic elements in the historical correction log, the video wrong phrase replacement program 150 may utilize a combination of the translation from the phoneme generator and the correction log or utilize only the correction log.

Then, at 208, the video wrong phrase replacement program 150 replaces an original audio clip associated with the one or more linguistic errors with the corresponding corrected audio segment. Once the correct word form has been created, the video wrong phrase replacement program 150 may utilize an audio integrator to replace the wrong word or phrase containing the linguistic error with the correct word created through audio synthesis. The audio integrator may allow for integration of synthesized audio segments into the original audio content while preserving the natural flow and tone of the speaker's speech. For example, continuing the previous example where the word “population” was incorrectly used instead of the word “pollution”, the video wrong phrase replacement program 150 may remove the word “population” from the original audio clip and seamlessly replace it with the word “pollution”. In one or more embodiments, the video wrong phrase replacement program 150 may modify tone, inflection, volume, or another speech characteristic of the original audio clip surrounding or juxtaposed to the portion of the multimedia file where the corrected audio segment will be inserted or replace the error so that the speaker's voice remains smooth and flows naturally in the post-replacement audio clip.

Next, at 210, the video wrong phrase replacement program 150 modifies a lip animation of a video clip associated with the one or more linguistic errors and the corrected audio segment to match the corrected audio segment. Once the corrected audio is embedded within the audio segment, the video wrong phrase replacement program 150 may modify the lip animation of the speaker in the video clip to match the corrected word or phrase. The video wrong phrase replacement program 150 may utilize a lip animation synchronizer to correlate the lip animation of the speaker to match the video with the corrected audio. The lip animation synchronizer may utilize the lip animations emoted by the speaker when speaking the same phonemes used to create the corrected word. Similar to the audio synthesizer, the video wrong phrase replacement program 150, through the lip animation synchronizer, may identify the various lip animations associated with the phonetic elements translated by the phoneme generator or through lip animations stored in the historical correction log associated with their corresponding phonetic elements. For example, the video wrong phrase replacement program 150 may identify the phonetic elements in the short form video or in the correction log associated with the various clips or snippets that make up the corrected word “pollution” and generate a single, fluid lip animation of the speaker speaking the corrected word “pollution”.

Although the phrase “lip animation” is used throughout to describe the movement of a speaker's lips when speaking or presenting and is typically related to computer-generated animation styles, live action movements of a real-world entity (e.g., human lip movements) captured by an image capture device (e.g., video recording device) may be modified by the video wrong phrase replacement program 150.

Then, at 212, the video wrong phrase replacement program 150 updates the original video with the modified video containing the corrected audio segment and the modified lip animation. Once generated, the video wrong phrase replacement program 150 may utilize a lip animation replacer to replace the wrong phrase lip animation with the modified lip animation associated with the corrected word or phrase. The video wrong phrase replacement program 150, through the lip animation replacer, may ensure a smooth transition from the previous phonetic element to the corrected word or phrase then to the following phonetic element that is not perceptible, or minimally perceptible, to a viewer of the short form video. For example, the video wrong phrase replacement program 150 may insert the generated lip animation for “pollution” in place of the lip animation of “population” in the short form video then smooth the transition from the word before “pollution” (i.e., “reduce”) and the word after “pollution” (i.e., “more”) for a more viewer-friendly experience.

In one or more embodiments, the video wrong phrase replacement program 150 may require the user confirm the updates before saving or uploading the short form video to a short form video platform. Furthermore, to avoid misuse, the video wrong phrase replacement program 150 may require a verification that the speaker in the short form video approves the correction of their originally spoken words or phrases before the video wrong phrase replacement program 150 may allow saving of the corrected short form video through one or more verification techniques. For example, the video wrong phrase replacement program 150 may identify a speaker in a short form video through facial recognition, biometric data, or another user verification technique, and require a complimentary facial analysis or verification technique of the speaker followed by a user interaction with a GUI to confirm that the speaker is the user interacting with the video wrong phrase replacement program 150 and that the user agrees to the changes being made to the short form video.

In another embodiment, the video wrong phrase replacement program 150 may update the correction log after each user-approved correction thereby expanding the base for the machine learning model for identifying errors and providing a broader spectrum of phonemes and lip animations on which to draw in future use cases.

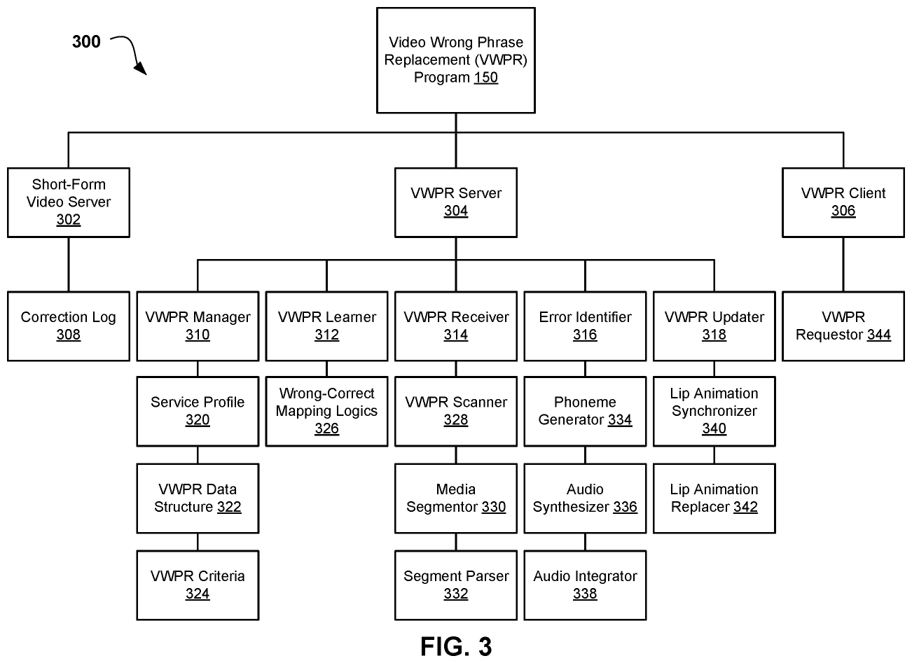

Referring now to FIG. 3, a functional block diagram of software components 300 used in the video wrong phrase replacement process 200 is depicted according to at least one embodiment. During operation through the steps of FIG. 2, the video wrong phrase replacement program 150 may interact with various sub-programs, sub-routines, and/or modules include, but not limited to, short-form video server 302, video wrong phrase replacement server 304, video wrong phrase replacement client 306.

Short-form video server 302 may be a storage and communication platform for providing short-form video services that allow users to upload, view, and share short-form video. Short-form video server 302 may retain a correction log 308 in a repository, such as storage 124 or report database 130, that documents audio and video corrections made by the wrong phrase replacement program 150 when correcting videos to remove language errors, grammatical mistakes, and/or inappropriate content.

Video wrong phrase replacement server 304 may be a server for receiving users' requests from clients to support the wrong phrase replacement program 150 and empower administrators, creators, and/or audiences to correct review, adjust, and approve video content corrections. In at least one embodiment, the wrong phrase replacement program 150 may host or communicate with video wrong phrase replacement manager 310, video wrong phrase replacement learner 312, video wrong phrase replacement receiver 314, error identifier 316, video wrong phrase replacement updater 318, service profile 320, video wrong phrase replacement data structure 322, video wrong phrase replacement criteria 324, wrong-correct mapping logics 326, video wrong phrase replacement scanner 328, media segmentor 33, segment parser 332, phoneme generator 334, audio synthesizer 336, audio integrator 338, lip animation synchronizer 340, and lip animation replacer 342.

Video wrong phrase replacement manager 310 may utilize a user interface for users to configure and customize settings for the video wrong phrase replacement program 150, attributes of the video wrong phrase replacement data structure 322, and/or video wrong phrase replacement criteria 324, such as, but not limited to language/locale, restricted words and phrases with suggested replacement candidates, etc. The video wrong phrase replacement program 150 may save the configurations, settings, attributes of the video wrong phrase replacement data structure 322, and video wrong phrase replacement criteria 324 into a profile, such as service profile 320, which may be stored in a repository, such as storage 124. The video wrong phrase replacement data structure 322 may be a specialized data structure with related algorithms for saving, tracking, and updating data associated with the video wrong phrase replacement program 150. The data may include, but is not limited to, a video ID, an audio segment ID, an audio speaker ID, an audio time length, an audio text segment ID, an audio text speaker IDS, an audio text time length, a video segment ID, a video speaker ID, a video time length, wrong phrase text, wrong phrase audio, wrong phrase lip animation, correct phrase text, correct phrase audio, correct phrase lip animation, and updated correct caption and audio. The video wrong phrase replacement criteria 324 may be a set of algorithms and related correction rules for handling the posted video content correction.

The video wrong phrase replacement learner 312 may be a module for learning wrong-correct phrases from defined wrong-correct mapping logics 326 and correction log 308. For example, if one user corrected “John bring all the luggages. Please tell he to put them in the car” to “John brings all the luggage. Please tell him to it in the car”, the correction operation may be saved in a log file for learning the new correction types and new correction logics. The wrong-correct mapping logics 326 may be a set of wrong-correction tables and the associated correction logics for correcting the posted short form videos in a short form video server, such as video wrong phrase replacement server 304.

The video wrong phrase replacement receiver 314 may be a module for receiving regulation and moderation requests from users. The video wrong phrase replacement scanner 328 may be a module for scanning each original media (e.g., audio and/or video) in a user-selected set of media files. Media segmentor 330 may be a module for segmenting media content into specific lengths according to speaker/role or sentence separators. Segment parser 332 may be a module for parsing the segment into basic elements, such as words, phrases, and associated phonemes.

Error identifier 316 may be a module for identifying wrong phrase audio in the segmented content. The error identifier 316 may linguistically analyze the segmented content using text-to-speech technology and/or natural language processing techniques to determine when a word or phrase is inappropriately used in the segment. A correction recommender may then be used to recommending the correct phrase with which to replace the identified wrong phrase audio. The phoneme generator 334 may be a module for generating accurate phonetic elements (i.e., phonemes) of the corrections required according to the recommended correction phrases and speaker voice profiles. For examples, the phoneme generator 334 may execute calls that may be written as “PhonemeGenerator(“her”)=//hεr/”, “PhonemeGenerator(“has”)=/hæz//”, and “PhonemeGenerator(“POLLUTION”)=”. Audio synthesizer 336 may be a module for synthesizing the corrected audio segments based on the generated accurate phonetic elements. Additionally, audio integrator 338 may be a module for integrating the synthesized corrected audio segments into the original audio content while preserving the natural flow and tone of the speaker's speech.

The video wrong phrase replacement updater 318 may be a module for updating the original video segment with the moderated segment. The video wrong phrase replacement updater 318 may include utilize the lip animation synchronizer 340 and lip animation replacer 342. The lip animation synchronizer 340 may be a module for synchronizing the correlated lip animation of speakers in the associated video accordingly with the integrated corrected audio. The lip animation replace 342 may be a module for replacing the wrong phrase lip animation with the synchronized lip animation.

The video wrong phrase replacement client 306 may be a client for sending users' requests to the video wrong phrase replacement server 304 to support the video wrong phrase replacement program 150 on a client device, such as computer 101 or end user device 103, and empower user to correct, review, adjust, and approve video content. The video wrong phrase replacement requester 344 may be a module, such as an application programming interface (API) or graphical user interface (GUI) for sending regulation and moderation requests to the video wrong phrase replacement receiver 314. For example, an administrator may set the video wrong phrase replacement program 150 to scan entire short form videos and correct any predefined or learned wrong phrases.

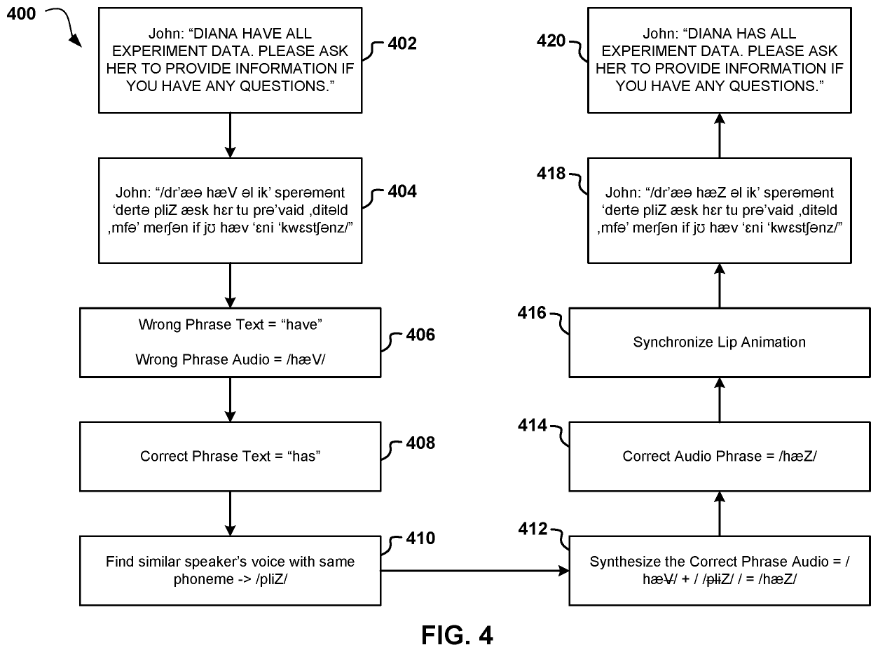

Referring now to FIG. 4, an exemplary flowchart for synthesizing a speaker's audio and synchronizing lip animations 400 is depicted according to at least one embodiment. During the process of creating a short form video, a user, John, may wish to review a segment that he recorded for accuracy. Therefore, at 402, John uploads the short form video to the video wrong phrase replacement program 150, which begins analysis of the short form video and identifies the audio spoken during the video as “Diana have all experiment data. Please ask her to provide information if you have any questions”. At 404, the video wrong phrase replacement program 150 may translate the identified audio clip into the corresponding phonetic elements (e.g.. “/dr ae [symbol] k’sper [symbol] m [symbol] nt ‘dert [symbol] pliZ aesk her tu pr [symbol] vaid, dit [symbol] ld, mf [symbol] ’ [symbol] if [symbol] ‘ [symbol] lwestf [symbol] /”) At 406, once the phonetic elements have been translated or generated, the video wrong phrase replacement program 150 may utilize a machine learning model and/or a historical correction log to identify any linguistic errors, grammatical mistakes, and/or inappropriate words or phrases. In the instant case, the video wrong phrase replacement program 150 may determine the word “have” and phonetic element “hoV” are incorrectly used in the short form video and need correction. At 408, the video wrong phrase replacement program 150, again through the machine learning model and/or the historical correction log, may determine the appropriate word required to correct the error is “has”. At 410, the video wrong phrase replacement program 150 may identify the phonetic elements required to correct the incorrected word (i.e., “have”) to the correct word (i.e., “has”) and locate the phonetic element either within the short form video or within the historical correction log. For example, the video wrong phrase replacement program 150 may determine the phonetic element “V” should be replaced with the phonetic element “Z” in the word “have” to create the word “has” and, therefore, may identify the word “please” in the short form video has the phoneme “pliZ”, which includes the phonetic element “Z” required to generate the word “has”. At 412, the video wrong phrase replacement program 150 may synthesize the correct word or phrase audio from the identified phonetic elements. Using the identified phonetic element “hæ” from the original incorrect word, since that phonetic element will remain the same in the corrected word, and the phonetic element “Z” identified as needed to make the word “has”, the video wrong phrase replacement program 150 may combine the phonetic elements (i.e., “hæ” and “Z”) to create the phoneme “hæZ”. At 414, the video wrong phrase replacement program 150 may add the correct audio phrase (i.e., “hæZ”) to the short form video using an audio integrator module. At 416, the video wrong phrase replacement program 150 synchronizes the speaker lip animations to match the corrected word or phrase. For example, the video wrong phrase replacement program 150 may utilize the machine learning model, corresponding lip animations for the phonetic elements used to create the correct word audio, and/or the correction log, to generate a lip animation of the speaker speaking the correct word or phrase then replace the original lip animation of the speaker with the corrected lip animation. Then, at 418, the video wrong phrase replacement program 150 may return the phonetic elements of the short form video that incorporates the corrected word “pollution” through the phoneme generator which, at 420, may output the corrected short form video that recites the sentence “Diana has all experiment data. Please ask her to provide information if you have any questions.”

It may be appreciated that FIGS. 2-4 provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
in response to identifying an error spoken by a presenter in a multimedia file, generating a plan to correct the error;
generating a corrected audio segment based on the plan;
replacing an original audio segment in the multimedia file containing the error with the corrected audio segment;
modifying a lip movement in a video segment of the multimedia file so lip movements of the presenter correspond to respective phonetics in the corrected audio segment; and
replacing an original lip movement with the modified lip movement so that the modified lip movement corresponds with the corrected audio segment.

2. The method of claim 1, wherein generating the corrected audio segment further comprises:
extracting the original audio segment from the multimedia file;
translating the original audio segment to phonetic elements;
identifying one or more phonetic elements of the original audio segment associated with the error;
identifying one or more phonetic elements, in the original audio segment or in a historical correction log, that correspond to a corrected word or phrase in the corrected audio segment; and
generating the corrected audio segment from the one or more phonetic elements that correspond to the corrected word or phrase.

3. The method of claim 1, wherein identifying an error further comprises:
separating the original audio segment based on a speaker or by sentence;
parsing the separated original audio segments into phonetic elements; and
identifying an error within the phonetic elements based on a machine learning model or a historical correction log.

4. The method of claim 1, wherein generating the plan further comprises utilizing a machine learning model or a historical correction log to determine a best fit word or phrase to place the error in the multimedia file.

5. The method of claim 1, further comprising:
prompting a user to confirm updates prior to saving or uploading the multimedia file with the corrected audio segment and replaced lip movement, wherein confirming comprises the user being verified as the presenter in the multimedia file using biometric data.

6. The method of claim 1, wherein replacing the original audio segment further comprises:
modifying a speech characteristic of audio data juxtaposed to the corrected audio segment in the multimedia file, wherein the speech characteristic is selected from a group consisting of tone, inflection, and volume.

7. The method of claim 1, wherein the error is selected from a group consisting of a language error, a grammatical mistake, and inappropriate content.

8. A computer system, the computer system comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
in response to identifying an error spoken by a presenter in a multimedia file, generating a plan to correct the error;
generating a corrected audio segment based on the plan;
replacing an original audio segment in the multimedia file containing the error with the corrected audio segment;
modifying a lip movement in a video segment of the multimedia file so lip movements of the presenter correspond to respective phonetics in the corrected audio segment; and
replacing an original lip movement with the modified lip movement so that the modified lip movement corresponds with the corrected audio segment.

9. The computer system of claim 8, wherein generating the corrected audio segment further comprises:
extracting the original audio segment from the multimedia file;
translating the original audio segment to phonetic elements;
identifying one or more phonetic elements of the original audio segment associated with the error;
identifying one or more phonetic elements, in the original audio segment or in a historical correction log, that correspond to a corrected word or phrase in the corrected audio segment; and
generating the corrected audio segment from the one or more phonetic elements that correspond to the corrected word or phrase.

10. The computer system of claim 8, wherein identifying an error further comprises:
separating the original audio segment based on a speaker or by sentence;
parsing the separated original audio segments into phonetic elements; and
identifying an error within the phonetic elements based on a machine learning model or a historical correction log.

11. The computer system of claim 8, wherein generating the plan further comprises utilizing a machine learning model or a historical correction log to determine a best fit word or phrase to place the error in the multimedia file.

12. The computer system of claim 8, the method further comprises:
prompting a user to confirm updates prior to saving or uploading the multimedia file with the corrected audio segment and replaced lip movement, wherein confirming comprises the user being verified as the presenter in the multimedia file using biometric data.

13. The computer system of claim 8, wherein replacing the original audio segment further comprises:
modifying a speech characteristic of audio data juxtaposed to the corrected audio segment in the multimedia file, wherein the speech characteristic is selected from a group consisting of tone, inflection, and volume.

14. The computer system of claim 8, wherein the error is selected from a group consisting of a language error, a grammatical mistake, and inappropriate content.

15. A computer program product, the computer program product comprising:
one or more computer-readable tangible storage media and program instructions stored on at least one of the one or more tangible storage media, the program instructions executable by a processor capable of performing a method, the method comprising:
in response to identifying an error spoken by a presenter in a multimedia file, generating a plan to correct the error;
generating a corrected audio segment based on the plan;
replacing an original audio segment in the multimedia file containing the error with the corrected audio segment;
modifying a lip movement in a video segment of the multimedia file so lip movements of the presenter correspond to respective phonetics in the corrected audio segment; and
replacing an original lip movement with the modified lip movement so that the modified lip movement corresponds with the corrected audio segment.

16. The computer program product of claim 15, wherein generating the corrected audio segment further comprises:
extracting the original audio segment from the multimedia file;
translating the original audio segment to phonetic elements;
identifying one or more phonetic elements of the original audio segment associated with the error;
identifying one or more phonetic elements, in the original audio segment or in a historical correction log, that correspond to a corrected word or phrase in the corrected audio segment; and
generating the corrected audio segment from the one or more phonetic elements that correspond to the corrected word or phrase.

17. The computer program product of claim 15, wherein identifying an error further comprises:
separating the original audio segment based on a speaker or by sentence;
parsing the separated original audio segments into phonetic elements; and
identifying an error within the phonetic elements based on a machine learning model or a historical correction log.

18. The computer program product of claim 15, wherein generating the plan further comprises utilizing a machine learning model or a historical correction log to determine a best fit word or phrase to place the error in the multimedia file.

19. The computer program product of claim 15, the method further comprises:
prompting a user to confirm updates prior to saving or uploading the multimedia file with the corrected audio segment and replaced lip movement, wherein confirming comprises the user being verified as the presenter in the multimedia file using biometric data.

20. The computer program product of claim 15, wherein replacing the original audio segment further comprises:
modifying a speech characteristic of audio data juxtaposed to the corrected audio segment in the multimedia file, wherein the speech characteristic is selected from a group consisting of tone, inflection, and volume.
